(19) United States
(12) Patent Application Publication
(10) Pub. No.: US 2013/0340876 A1
(43) Pub. Date: Dec. 26, 2013

(54) IMPLEMENTING LEAK PREVENTION OF WATER COOLING HOSES

(71) Applicants: Dylan J. Boday, Tucson, AZ (US); Jason T. Wertz, Wappingers Falls, NY (US)

(72) Inventors: Dylan J. Boday, Tucson, AZ (US); Jason T. Wertz, Wappingers Falls, NY (US)

(73) Assignee: INTERNATIONAL BUSINESS MACHINES CORPORATION, Armonk, NY (US)

(21) Appl. No.: 13/527,750

(22) Filed: Jun. 20, 2012

(51) Int. Cl. F16L 11/20; B05D 1/18; B05D 7/00; F16L 11/04

(52) U.S. Cl. 138/137; 138/177; 427/430.1; 427/393.5; 427/398.1

(57) ABSTRACT

A method and structure are provided for implementing leak prevention of water cooling hoses. A water cooling hose includes an inner hose layer and an outer hose layer. Potential water leaks are prevented from the water cooling hose or tubing by sealing of the cut end of the tubing after sizing of the water cooling hose has been completed. The cut end of the water cooling hose is dipped into a selected solution bath, and upon removal a seal is formed before hose assembly is provided.

### FIELD OF THE INVENTION

The present invention relates generally to the data processing field, and more particularly, relates to a method and structure for implementing leak prevention of water cooling hoses, including flexible synthetic rubber tubing.

### DESCRIPTION OF THE RELATED ART

Current high performance computer systems have rapidly migrated to water cooling solutions to effectively remove the massive heat load from the central electronic complex (CEC). The system design typically includes a flexible tubing option incorporating a large number of connections to a cold plate/heat sink. Restrictions on the tubing material choice present a challenge to ensure adequate product reliability.

A need exists for a method and structure for implementing leak prevention of water cooling hoses. It is desirable to provide an efficient and effective method and structure for implementing leak prevention of water cooling hoses including an ethylene propylene diene monomer (EPDM) inner hose, a reinforcement layer, and an EPDM outer hose.

EPDM rubber (ethylene propylene diene monomer rubber) is a type of synthetic rubber, which is an elastomer or a polymer with viscoelasticity, often used in water cooling applications.

### SUMMARY OF THE INVENTION

Principal aspects of the present invention are to provide a method and structure for implementing leak prevention of water cooling hoses. Other important aspects of the present invention are to provide such method and structure substantially without negative effects and that overcome many of the disadvantages of prior art arrangements.

In brief, a method and structure are provided for implementing leak prevention of water cooling hoses. A water cooling hose includes an inner hose layer and an outer hose layer. Potential water leaks are prevented from a cut end of water cooling hose or tubing by the sealing of the cut end of the tubing after sizing of the water cooling hose has been completed. The cut end of the water cooling hose is dipped into a selected solution bath, and upon removal a seal is formed. The sealed end of the water cooling hose prevents water from leaking out of the tubing between inner and outer layers of the water cooling hose. Then the water cooling hose is assembled with a conventional hardware, such as a barb fitting and clamping hardware.

In accordance with features of the invention, the water cooling hose is formed of a polymer with viscoelasticity, including an ethylene propylene diene monomer (EPDM) inner hose, a reinforcement layer, and an EPDM outer hose, which contains unsaturated diene functionalities. The unsaturated diene functionalities are residuals from a typical curing process which is achieved, for example, either by sulfur vulcanization or by free radical cure.

In accordance with features of the invention, the reactive solution bath includes, for example, a solution containing EPDM, sulfur and zinc oxide that is coated onto the end of the water cooling hose. The hose is then placed into an oven at an elevated temperature to create the reaction with the hose surface.

In accordance with features of the invention, the unreactive solution bath includes, for example, a solution containing polyurethane dissolved into toluene that is coated onto the end of the water cooling hose. The hose is then placed aside for the solvent to evaporate leaving a polymer coating on the end of the hose.

In accordance with features of the invention, the cut end of the EPDM water cooling hose is dipped in a solution bath, for example, including a polymer/monomer solution and an initiating source. As the hose is dipped into the bath, the initiating source reacts with the monomer forming polymer with the residual diene functionalities on the EPDM hose surface. Upon removal of the hose from the bath, the solution cures forming a seal around the end of the multilayer hose structure, thus preventing leaks.

In accordance with features of the invention, the cut end of the water cooling hose is dipped in a solution bath, for example, including a selected polymer solution which is above the melt temperature of a polymer forming the water cooling hose or a selected polymer solution containing a suitable solvent being used to seal the hose ends. Example polymers include polyethylene, polypropylene, epoxies, and polyurethanes. The hose is removed from the polymer solution and allowed to cool. Upon cooling, the polymer transitions from a liquid to a solid allowing the seal to form on the hose edges to prevent hose leaks. The amount of polymer added to the surface can be optimized to improve the burst strength or the seal thickness.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a flow chart illustrating exemplary steps for manufacturing a water cooling hose for implementing leak prevention of water cooling hoses in accordance with the preferred embodiment;

FIG. 2A and FIG. 2B are flow charts illustrating alternative exemplary steps for implementing leak prevention of water cooling hoses in accordance with the preferred embodiment;

FIG. 3A and FIG. 3B are a cross-sectional view and a side view schematically illustrating not to scale initial processing for an example water cooling hose in accordance with the preferred embodiment;

FIG. 3C schematically illustrates example processing steps for the water cooling hose of FIG. 3A and FIG. 3B in accordance with the preferred embodiment

FIG. 3D and FIG. 3E are a cross-sectional view and a side view schematically illustrating not to scale a sealed water cooling hose in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and structure are provided for implementing leak prevention of water cooling hoses including an ethylene propylene diene monomer (EPDM) inner hose, a reinforcement layer, and an EPDM outer hose.

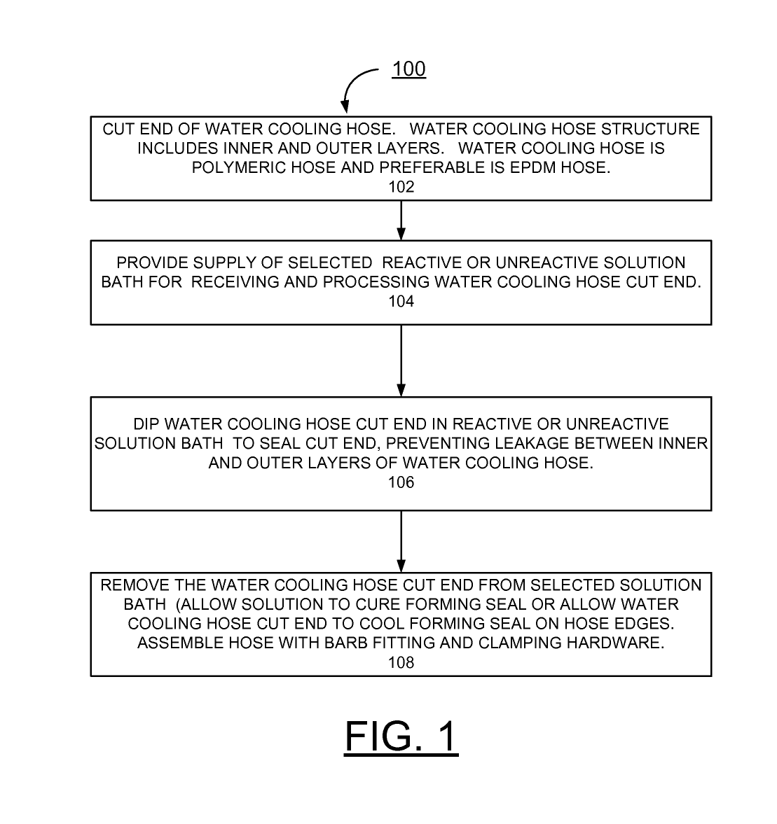

Having reference now to the drawings, in FIG. 1, there is shown a flow chart illustrating example steps generally designated by reference character 100 for manufacturing water cooling hoses in accordance with a preferred embodiment.

As indicated at a block 102, an end of a water cooling hose is cut to provide a desired size. The water cooling hose includes an inner hose layer and an outer hose layer, and preferable includes an ethylene propylene diene monomer (EPDM) inner hose, a reinforcement layer, and an EPDM outer hose layer.

In accordance with features of the invention, potential water leaks are prevented from a cut end of water cooling hose or tubing by sealing of the cut end of the tubing after sizing of the water cooling hose has been completed.

As indicated at a block 104, a supply of a reactive or unreactive solution bath is provided for receiving and processing the water cooling hose cut end.

As indicated at a block 106, the cut end of the water cooling hose is dipped into the reactive or unreactive solution bath, and upon removal a seal is formed. The water cooling hose sealed end prevents water from leaking out of the tubing between inner and outer layers of the water cooling hose.

As indicated at a block 108, the cut end of the water cooling hose is removed from the selected solution bath, and the solution is allowed to cure forming a seal or allowed to cool forming a seal depending upon the solution bath provided. Then the water cooling hose is assembled with a conventional hardware, such as a barb fitting and clamping hardware.

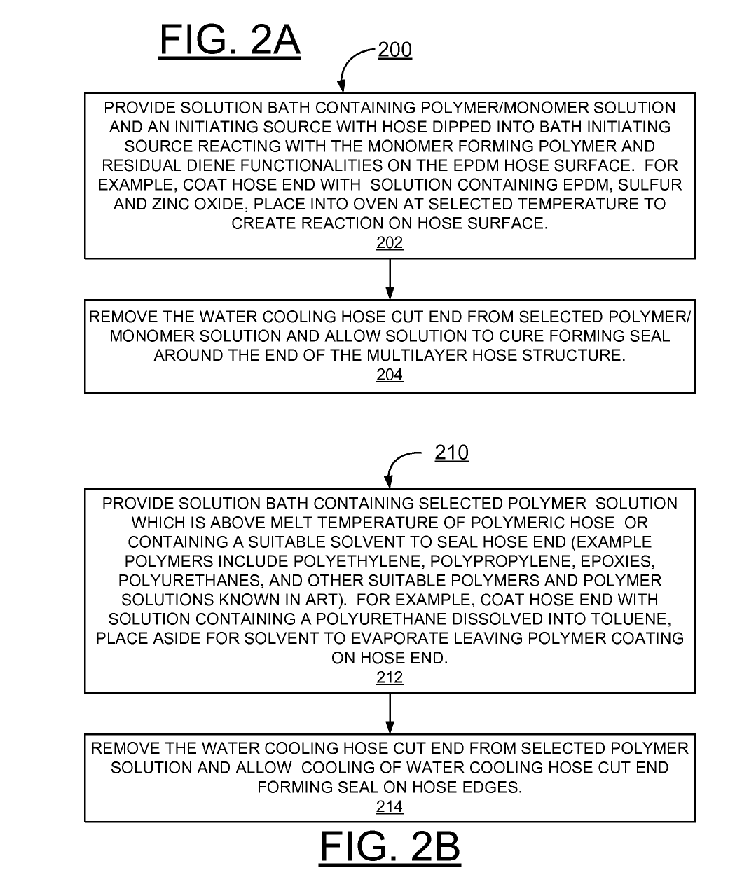

Referring now to FIG. 2A and FIG. 2B, there are shown alternative exemplary steps for implementing leak prevention of water cooling hoses in accordance with the preferred embodiment.

In FIG. 2A, example processing steps generally designated by reference character 200 are shown for manufacturing water cooling hoses in accordance with the preferred embodiment. As indicated at a block 202, a solution bath receiving the cut end of the EPDM water cooling hose that is dipped into the solution bath, for example, includes a polymer/monomer solution and an initiating source.

As the hose is dipped into the bath at a block 202, the initiating source is reacting with the monomer forming polymer with the residual diene functionalities on the EPDM hose surface. For example, the hose end is coated with a solution bath including ethylene propylene diene monomer (EPDM), sulfur and zinc oxide; and is then placed into an oven at an elevated temperature for heating the water cooling hose to create the reaction on the hose surface. As indicated at a block 204, upon removal of the hose from the bath, the solution cures forming a seal around the end of the multilayer hose structure, thus preventing leaks.

In FIG. 2B, example processing steps generally designated by reference character 210 are shown for manufacturing water cooling hoses in accordance with the preferred embodiment. As indicated at a block 212, the cut end of the water cooling hose is dipped in a solution bath, for example, including a selected polymer solution which is above the melt temperature of a polymer forming the water cooling hose or a selected polymer solution containing a suitable solvent being used to seal the hose ends. Example polymers include polyethylene, polypropylene, epoxies, and polyurethanes. The hose is removed from the polymer solution and allowed to cool. For example, the hose end is coated with a solution bath including polyurethane dissolved into toluene, and the coated hose end is placed aside for the solvent toluene to evaporate leaving the polymer coating to form the seal on the hose end.

As indicated at a block 214, upon cooling, the polymer transitions from a liquid to a solid allowing for a seal to form on the hose edges to prevent hose leaks. The amount of polymer added to the surface can be optimized to improve the burst strength or the seal thickness.

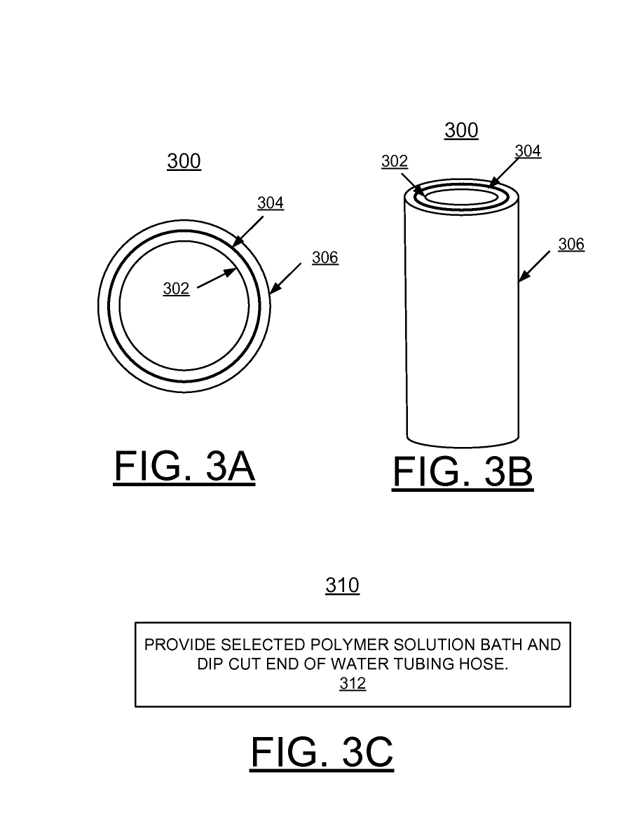

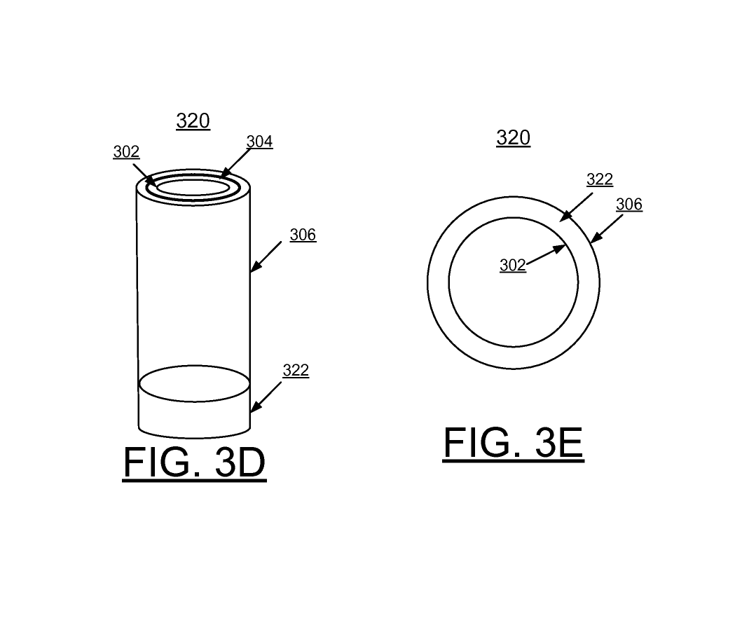

Referring now to FIG. 3A and FIG. 3B, there are shown a cross-sectional view and a side view schematically illustrating not to scale initial processing for an example water cooling hose generally designated by reference character 300 in accordance with the preferred embodiment. The water cooling hose 300 is cut or sized for a particular application and includes an ethylene propylene diene monomer (EPDM) inner hose layer 302, a reinforcement layer 304, and an EPDM outer hose layer 306.

FIG. 3C schematically illustrates an example processing generally designated by reference character 310 for the water cooling hose 300 in accordance with the preferred embodiment. A selected polymer solution bath is provided and the cut end of the water tubing hose 300 is dipped into the polymer solution bath as indicated at a block 312.

Referring now to FIG. 3D and FIG. 3E, there are shown a cross-sectional view and a side view schematically illustrating not to scale a sealed water cooling hose generally designated by reference character 320 in accordance with the preferred embodiment. In FIG. 3D and FIG. 3E, a sealed end 322 of the water cooling hose 320 is shown following the processing steps 310 in FIG. 3C.

While the present invention has been described with reference to the details of the embodiments of the invention shown in the drawing, these details are not intended to limit the scope of the invention as claimed in the appended claims.

What is claimed is:

1. A method for implementing leak prevention of water cooling hoses comprising:
providing a water cooling hose including an inner hose layer and an outer hose layer and having a cut end of water cooling hose;
providing a selected solution bath;
dipping the cut end of the water cooling hose into the provided solution bath, and
removing the cut end of the water cooling hose from the solution bath for forming a seal to prevent water from leaking between the inner hose layer and the outer hose layer.

2. The method as recited in claim 1 wherein providing said water cooling hose includes forming said water cooling hose of a polymer with viscoelasticity and said water cooling hose includes a reinforcement layer between the inner and outer hose layers.

3. The method as recited in claim 1 wherein providing said water cooling hose includes forming said water cooling hose including an ethylene propylene diene monomer (EPDM) inner hose layer, and an EPDM outer hose layer, said EPDM outer hose layer containing unsaturated diene functionalities.

4. The method as recited in claim 3 wherein providing said selected solution bath includes providing a solution bath including a polymer/monomer solution and an initiating source.

5. The method as recited in claim 4 wherein dipping the cut end of the water cooling hose into said provided solution bath includes said initiating source reacting with the monomer forming polymer and the residual diene functionalities on the EPDM hose surface.

6. The method as recited in claim 5 wherein removing the cut end of the water cooling hose from the solution bath for forming said seal includes said solution curing and forming said seal around the end of said EPDM inner hose layer and said EPDM outer hose layer.

7. The method as recited in claim 1 wherein providing said selected solution bath includes providing a solution bath including a selected polymer solution containing a suitable solvent to seal the hose ends.

8. The method as recited in claim 1 wherein providing said selected solution bath includes providing a solution bath including a selected polymer solution which is lower than a melt temperature of a polymer forming the water cooling hose.

9. The method as recited in claim 8 wherein said selected polymer solution is a selected polymer from a group including polyethylene, polypropylene, polyvinylchloride, polyvinyl acetate, vinylidene chloride, epoxies, and polyurethanes.

10. The method as recited in claim 8 wherein removing the cut end of the water cooling hose from the solution bath for forming said seal includes cooling and said polymer transitioning from a liquid to a solid allowing said seal to form on edges of the cut hose end.

11. The method as recited in claim 1 wherein providing said selected solution bath includes providing a solution bath including a polyurethane dissolved into toluene, and includes the solvent toluene evaporating leaving a polymer coating to form the seal on the hose end.

12. The method as recited in claim 1 wherein providing said selected solution bath includes providing a solution bath including an ethylene propylene diene monomer (EPDM), sulfur and zinc oxide; and includes heating the water cooling hose to create reaction on the hose surface.

13. A water cooling hose produced by a method as recited in claim 1.

14. A structure for implementing leak prevention of water cooling hoses comprising:
a water cooling hose including an inner hose layer and an outer hose layer and having a cut end of the water cooling hose; and
a seal formed on said cut end of the water cooling hose to prevent water from leaking between the inner hose layer and the outer hose layer.

15. The structure as recited in claim 14 wherein said water cooling hose includes a water hose formed of a polymer with viscoelasticity; and said water cooling hose includes a reinforcement layer between the inner and outer hose layers.

16. The structure as recited in claim 14 wherein said water cooling hose includes a water hose formed of an ethylene propylene diene monomer (EPDM) inner hose layer, an EPDM outer hose layer said EPDM outer hose layer containing unsaturated diene functionalities.

17. The structure as recited in claim 14 wherein said seal formed on said cut end of the water cooling hose includes a polymer seal formed by dipping the cut end of the water cooling hose into a selected reactive or unreactive solution bath

18. The structure as recited in claim 17 wherein said polymer seal is formed by coating the cut end of the water cooling hose with a solution containing ethylene propylene diene monomer (EPDM), sulfur and zinc oxide; and heating the coated water cooling hose to create reaction on the hose surface.

19. The structure as recited in claim 17 wherein said polymer seal is formed by coating the cut end of the water cooling hose with a solution containing a polyurethane dissolved into toluene, and the solvent toluene evaporating to form said polymer seal.
